(19) United States
(12) Patent Application Publication
(10) Pub. No.: US 2005/0184262 A1
(43) Pub. Date: Aug. 25, 2005

(54) Solenoid valve

(76) Inventors: Luis F. Barron, El Paso, TX (US); Viswanathan Subramanian, El Paso, TX (US)

Correspondence Address: JIMMY L. FUNKE;DELPHI TECHNOLOGIES, INC., Legal Staff Mail Code: 480-410-202, P.O. Box 5052, Troy, MI, 48007-5052, US

(21) Appl. No.: 10/783,567

(22) Filed: Feb. 20, 2004

(51) Int. Cl. F16K 31/02

(52) U.S. Cl. 251/129.14

(57) ABSTRACT

A solenoid valve has a rod that pushes a ball off a valve seat when the coil is energized. The rod is distanced from the ball when the coil is deenergized, such that upon energization of the coil, the rod can gain momentum before contacting the ball, thereby more quickly pushing the ball off the valve seat against the force of fluid pressure and, thus, enabling the valve to have a quick turn-on response time. The valve housing is made integrally with a winding bay and other features are provided to avoid unduly restrictive manufacturing tolerances.

### FIELD OF THE INVENTION

The present invention relates to solenoid valves.

### BACKGROUND OF THE INVENTION

Solenoid valves have many industrial applications. As one non-limiting example, vehicles can have numerous vehicle subsystems that are designed to increase the comfort and safety of drivers and passengers, such as anti-lock braking systems, traction control systems, speed control systems, vehicle stability enhancement control systems, and so on, and each subsystem can include numerous electromagnetic sensors and solenoid valves.

Typically, such valves include a rod attached to a plunger, with both rod and plunger reciprocating under the influence of electromagnetic force when a coil surrounding the plunger is energized and deenergized. More specifically, when the coil is energized the rod moves against a ball to push the ball away from a valve seat and thereby permit fluid flow through the seat. On the other hand, when the coil is deenergized the rod moves back to allow the ball (under the influence of fluid pressure) to move back against the seat, closing off fluid flow through the seat. To minimize rod wear against the ball, in the deenergized configuration the rod is positioned against or very close to (e.g., distanced very much less than 0.1 mm from) the ball.

As recognized herein, however, when the solenoid is energized and the rod starts its motion against the ball from a position in which it is in contact with the ball or very much less than 0.1 mm away from the ball, it builds up little or no momentum before it must push the ball away from the seat against the force of fluid pressure. This in turn translates to a relatively slow turn-on response time, a drawback in many systems that require relatively quick valve actuation times. The present invention, in addressing this problem, notes further that it is desirable to provide a solenoid valve with relatively fast turn-on response times without imposing unduly tight manufacturing tolerances.

### SUMMARY OF THE INVENTION

A solenoid valve includes a valve housing supporting a coil, a ball, and forming a valve seat. A rod is reciprocatingly disposed in the valve housing between a deenergized configuration, wherein the coil is deenergized and the ball is against the valve seat, and an energized configuration, wherein the coil is energized and the rod is urged against the ball to move the ball away from the valve seat. The valve housing defines the valve seat and is made integrally with a winding bay, with the coil being wound in the winding bay.

In preferred non-limiting embodiments the rod can be distanced from the ball by between one tenth and eight-tenths of a millimeter (0.1 mm-0.8 mm) inclusive, when in the deenergized configuration. The preferred valve housing is formed with at least one ball retainer rib defining a supply port having a first diameter. The ball has a larger diameter than the port and is disposed between the rib and valve seat such that the rib retains the ball from passing outward through the supply port. The housing may be injection molded around a steel primary plate and one or more terminals to form the valve seat and winding bay.

In another aspect, a solenoid valve for a vehicle includes a valve housing holding a rod, a ball, and forming a valve seat therebetween. The valve housing also defines a winding bay, and a coil is wound in the winding bay.

In still another aspect, a method for making a solenoid valve includes providing a metal primary plate and at least one terminal, and then injection molding a valve housing around the primary plate and terminal such that the housing forms at least one valve seat and at least one winding bay. The method also includes disposing a coil in the bay in contact with the terminal.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a cross-sectional view of the present solenoid valve in the deenergized configuration, schematically showing the processor, hydraulic system, and staking blades for engaging the plunger with the rod;

FIG. 2 is cross-section showing the details of the ball end of the valve; and

FIG. 3 is a side view of the preferred rod.

### DESCRIPTION OF THE PREFERRED EMBODIMENT

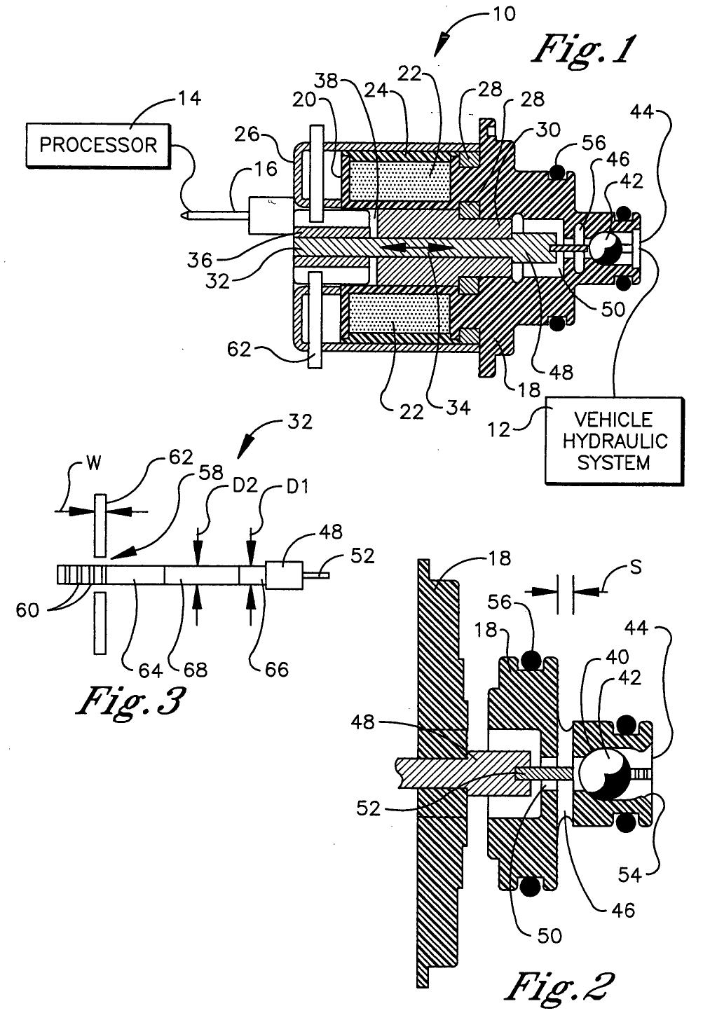

Referring initially to FIG. 1, a solenoid valve is shown, generally designated 10, which, in one illustrative embodiment, can be engaged with a vehicle hydraulic system 12 using one or more of the below-described fluid ports. The hydraulic system 12 can be any one of the systems mentioned above. The valve 10 can be controlled by a processor 14 such as a vehicle engine control module that is connected to terminals 16 of the valve 10 (only a single terminal 16 shown).

FIG. 1 shows that the valve 10 includes a preferably plastic housing 18. As shown, the preferred housing 18 defines a coil winding bay 20 in which a copper wire coil 22 is wound. If desired, the coil 22 can be overmolded with a plastic sleeve 24, with a can 26 enclosing the coil 22 and being crimped, rolled, pressed, or staked onto a preferably steel primary plate 28 that essentially is a disk formed with openings through which the valve housing 18 extends. The can 26 may be made of steel, ferrite, or other appropriate metal.

With the above disclosure in mind, it may now be appreciated that in the preferred embodiment, the valve housing 18 is not a separate component from the winding bay 20, but instead both are made integrally together, eliminating the need to assemble two separate components. To make the combination of structure shown in FIG. 1, the primary plate 28 and terminals 16 can be held in a mold, and then the valve housing is injection molded around the primary plate 28 and terminals 16, with the terminals 16 being positioned around the winding bay 20 such that the coil 22 can be connected to the terminals 16 once the coil 22 is disposed in the winding bay 20. This further reduces the requirement to separately engage the primary plate and terminals with the valve housing. During molding, the plastic housing/winding bay material flows through and around the primary plate 28 to form the winding bay 20 and below-described remainder of the valve housing 18. Less desirably, slots can be molded into the valve housing 18 through which components can be inserted. In any case, the primary plate 28 provides a strong foundation onto which the can 26 is mounted.

FIG. 1 also shows that an elongated hollow bushing 30 is disposed centrally in the valve housing 18 and is pressed onto the primary plate 28. The bushing 30, which may be made of steel, ferrite, or other appropriate metal, supports a rod 32 that is made of non-magnetic material and that reciprocates within the bushing 30 as indicated by the arrows 34. To move the rod 32, a portion of the rod 32 is engaged with (by, e.g., staking) a ferromagnetic plunger 36 which, when the valve 10 is in the deenergized configuration discussed more fully below, is distanced from the bushing 30 by an air gap 38.

FIGS. 1 and 2 show that the valve housing 18 defines a valve seat 40 that is blocked by a ball 42 when the valve is in the deenergized configuration to block fluid communication from a supply port 44 of the valve housing 18 to a control port 46 of the valve housing 18. In the deenergized configuration shown, an enlarged secondary valve element 48 of the rod 32 is distanced from an exhaust port 50 of the valve housing 18 by gravity or by fluid pressure or by a spring (not shown).

To move the ball 42 away from the valve seat 40, the preferred non-limiting rod 32, most of which defines a shaft made of non-ferromagnetic material, includes a preferably ferromagnetic or otherwise hardened pin 52 that can be press fit into the enlarged secondary valve element 48 of the rod 32 to contact the ball 42 when in the energized configuration as more fully disclosed below. Thus, the preferred rod 32 is a two-piece rod, with most of the rod being non-ferromagnetic and with the portion of the rod (i.e., the pin 52) that must repeatedly contact the ball 42 being hardened compared to the remainder of the rod, for better wear.

FIG. 2 best shows that the valve housing 18 is formed with at least one ball retainer rib 54 defining the supply port 44 and having a diameter that is smaller than that of the ball 42 such that the rib 54 retains the ball 42 from passing outward through the supply port 44. The rib 54 may be annular or there may be several, e.g., globular, ribs provided around the supply port 44, and the rib or ribs may be deformable such that the ball 42 may be pressed through the rib 54 into the location shown during installation, with the rib 54 then re-assuming the configuration shown. In addition, various o-rings 56 may be provided around the housing 18 for installation purposes known in the art.

With the above structural disclosure in mind, it may now be understood that the rod 32 is reciprocatingly disposed in the valve housing 18 between the deenergized configuration shown and an energized configuration. In the deenergized configuration, the coil 22 is deenergized, the ball 42 is forced by fluid pressure against the valve seat 40 to block fluid flow from the supply port 44 to the control port 46, and the secondary valve element 48 of the rod 32 is distanced from the exhaust port 50 by fluid pressure to allow fluid communication from the control port 46 through the exhaust port 50. In contrast, in the energized configuration, the coil 22 is energized to move the plunger 36 (and, hence, rod 32) to the right in FIG. 1, causing the ball 42 to be distanced from the valve seat 40 by the pin 52 to permit fluid flow from the supply port 44 to the control port 46, and moving the secondary valve element 48 of the rod 32 against the exhaust port 50 to block fluid communication therethrough.

In accordance with the present invention and as best shown in FIG. 2, in the deenergized configuration, the end of the pin 52 of the rod 32 is distanced from the ball 42 by a distance “S” of between one tenth and eight-tenths of a millimeter (0.1 mm-0.8 mm). Preferably, the distance “S” is approximately four-tenths of a millimeter (0.4 mm). This permits the rod 32/plunger 36 structure to pre-travel the distance “S” upon coil energization before contacting the ball 42, with the distance “S” being sufficient to reduce the turn-on response time of the valve compared to the turn-on response time it would have were the pin 52 to be spaced less than 0.1 mm from the ball 42 when in the deenergized configuration. Stated differently, with the above-disclosed pre-travel the rod 32/plunger 36 builds up substantial momentum under the influence of the coil when moving toward the ball 42 but before contacting the ball 42 such that when it does contact the ball 42, it quickly moves the ball 42 away from the valve seat 40.

FIG. 3 shows various preferred features of the rod 32. As shown, the portion 58 of the rod 32 that is received in the plunger 36 is formed with grooves 60. With this structure, the plunger 36 can be staked to the rod 32 using, e.g., stake blades 62 (which are removed after staking) having a width “W”. The blades are sufficiently wide such that during staking, material from the plunger 36 is evenly pushed into more than one groove 60 such that the forces created by the material being pressed into the corner of one groove are cancelled by the forces from material being pressed into the corner of another groove, minimizing unwanted movement between the plunger 36 and rod 32 during staking.

FIG. 3 also shows that to alleviate tolerance requirements, only a portion of the preferred rod 32 need be made to fit precisely in the bushing 30. More specifically, the rod 32 can be formed with first and second guiding surfaces 64, 66 between the pin 52 and grooved portion 58, with the guiding surfaces 64, 66 defining a diameter “D1”. Intermediate the guiding surfaces 64, 66, the rod 32 is formed with a stepped region 68 that defines a diameter “D2” which is smaller than the diameter “D1” of the guiding surfaces 64, 66. Only the first and second guiding surfaces 64, 66 need have tight tolerances for engaging the bushing 30.

While the particular SOLENOID VALVE as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

1. A solenoid valve, comprising:
a valve housing supporting a coil;
a ball in the valve housing;
a valve seat in the valve housing; and
a rod reciprocatingly disposed in the valve housing between a deenergized configuration, wherein the coil is deenergized and the ball is against the valve seat, and an energized configuration, wherein the coil is energized and the rod is urged against the ball to move the ball away from the valve seat, wherein the valve housing defines the valve seat and is made integrally with a winding bay, the coil being wound in the winding bay.

2. The valve of claim 1, wherein the rod is distanced from the ball by between one tenth and eight-tenths of a millimeter (0.1 mm-0.8 mm) inclusive, when in the deenergized configuration.

3. The valve of claim 1, wherein the valve housing is formed with at least one ball retainer rib defining a supply port having a first diameter, the ball being disposed between the rib and valve seat and defining a second diameter larger than the first diameter such that the rib retains the ball from passing outward through the supply port.

4. The valve of claim 1, wherein the valve housing is formed with at least one supply port, the ball being disposed between the supply port and valve seat, the valve housing also defining a control port and an exhaust port, fluid communication being blocked through the supply port and established through the exhaust and control ports in the deenergized configuration, fluid communication being blocked through the exhaust port and established through the supply and control ports in the energized configuration.

5. The valve of claim 1, further comprising a vehicle fluid system communicating with the valve.

6. The valve of claim 1, further comprising a primary plate and at least one terminal, the housing being injection molded around the primary plate and terminal to form at least the valve seat and winding bay.

7. A solenoid valve for a vehicle, comprising:
a valve housing holding a rod, a ball, and forming a valve seat therebetween, the valve housing also defining a winding bay, a coil being wound in the winding bay.

8. The valve of claim 7, wherein the valve housing is formed with at least one ball retainer rib defining a supply port having a first diameter, the ball being disposed between the rib and valve seat and defining a second diameter larger than the first diameter such that the rib retains the ball from passing outward through the supply port.

9. The valve of claim 7, wherein the valve housing is formed with at least one supply port, the ball being disposed between the supply port and valve seat, the valve housing also defining a control port and an exhaust port, fluid communication being blocked through the supply port and established through the exhaust and control ports in the deenergized configuration, fluid communication being blocked through the exhaust port and established through the supply and control ports in the energized configuration.

10. The valve of claim 7, further comprising a vehicle fluid system communicating with the valve.

11. The valve of claim 7, further comprising a primary plate and at least one terminal, the housing being injection molded around the primary plate and terminal to form at least the valve seat and winding bay.

12. A method for making a solenoid valve, comprising:
providing a metal primary plate and at least one terminal;
injection molding a valve housing around the primary plate and terminal such that the housing forms at least one valve seat and at least one winding bay;
disposing a coil in the bay in contact with the terminal.

13. The method of claim 12, further comprising engaging a valve can with the primary plate.

14. The method of claim 12, further comprising pressing at least one rod support bushing against the primary plate.

15. The method of claim 14, further comprising slidably disposing a rod in the bushing.
